(19) United States
(12) Patent Application Publication
(10) Pub. No.: US 2024/0152138 A1
(43) Pub. Date: May 9, 2024

(54) VEHICLE CONTROL SYSTEM AND CONTROL DEVICE

(71) Applicant: TOYOTA JIDOSHA KABUSHIKI KAISHA, Aichi-ken (JP)

(72) Inventors: Kosuke AKATSUKA, Mishima-shi (JP); Rio SUDA, Toyota-shi (JP)

(21) Appl. No.: 18/493,802

(22) Filed: Oct. 25, 2023

(30) Foreign Application Priority Data
Nov. 4, 2022 (JP) 2022-177257

(51) Int. Cl. G05D 1/00

(52) U.S. Cl. CPC G05D 1/0055; G05D 1/0011; G05D 2201/0213

(57) ABSTRACT

An object of the present disclosure is to provide a technique that enables a remote operator to operate a vehicle in the same manner as a driver who gets in the vehicle. A vehicle control system that controls a vehicle based on an operation amount input by a remote operator includes one or more processors. When a vehicle stop hold function for holding a vehicle stop state is operated, the one or more processors continue the operation of the vehicle stop holding function when there is no input of an accelerator operation by a remote operator, and cancel the operation of the vehicle stop holding function when the input of the accelerator operation by the remote operator is received.

### CROSS-REFERENCE TO RELATED APPLICATION

The present application claims priority under 35 U.S.C. § 119 to Japanese Patent Application No. 2022-177257, filed Nov. 4,2022, the contents of which application are incorporated herein by reference in their entirety.

### BACKGROUND

### Field

The present disclosure relates to a technique for controlling a vehicle which is a target of a remote operation.

### Background Art

JP2021-026558 discloses a technique related to a driving control system that controls driving of a vehicle. The vehicle, which is controlled by the driving control system, has a riding driving mode, a remote driving mode, and an autonomous driving mode as driving modes. The riding driving mode is a mode in which a driver riding in the vehicle drives the vehicle. The remote driving mode is a mode in which a remote driver operator outside the vehicle remotely drives the vehicle by operating the remote operation device. The autonomous driving mode is a mode in which an autonomous driving control unit included in the driving control system autonomously drives the vehicle.

### SUMMARY

A technique for remotely operating a vehicle by an operation of a remote operator is known. When the remote operator remotely operates the vehicle, it is desirable for the remote operator to be able to operate the vehicle in the same manner as when driving the vehicle as a driver riding in the vehicle. If behavior of the vehicle in response to the operation of the remote operator is different from behavior in response to an operation of the driver, there is a possibility that the remote operator feels uneasy. An object of the present disclosure is to provide a technique that enables the remote operator to operate the vehicle in the same manner as a driver riding in the vehicle.

A first aspect of the present disclosure relates to a vehicle control system that controls a vehicle based on an operation amount input by a remote operator. The vehicle control system comprises one or more processors. When a stop hold function that holds a stopped state of the vehicle is in operation, the one or more processors continues the operation of the stop hold function when an acceleration operation is not input by the remote operator and cancels the operation of the stop hold function when the acceleration operation is input by the remote operator.

A second aspect of the present disclosure relates to a control device mounted on a vehicle comprising a stop hold function that holds a stopped state of the vehicle. The control device comprises one or more processors. The one or more processors receives an operation amount input by a remote operator from a remote cockpit and executes a first process that determines a requested acceleration based on the received operation amount. The first process includes setting the requested acceleration to 0 or less when an acceleration operation is not input by the remote operator. An operation of the stop hold function is canceled when the requested acceleration determined by the first process becomes higher than 0.

According to a technique of the present disclosure, when a vehicle is remotely operated by a remote operator, operation of a stop hold function is also canceled or continued by an operation similar to that when the vehicle is manually driven. It is possible to reduce a sense of uneasy of the remote operator due to a difference in behavior of the vehicle between when the vehicle is remotely driven and when the vehicle is driven by a driver.

### BRIEF DESCRIPTION OF THE DRAWINGS

FIG. 1 is a block diagram showing a configuration example of a remote control system.

FIG. 2 is a block diagram for explaining control of a vehicle by a vehicle control system.

FIG. 3A is a diagram for explaining a first example of an embodiment.

FIG. 3B is another diagram for explaining a first example of an embodiment.

FIG. 4 is a block diagram showing a configuration example of the vehicle control system according to a second example of the embodiment.

FIG. 5 is a block diagram showing a configuration example of the vehicle control system according to a third example of the embodiment.

FIG. 6 is a flowchart showing an example of processing executed by the vehicle control system.

### DETAILED DESCRIPTION

Embodiments of the present disclosure will be described with reference to the accompanying drawings.

### 1. Overview of Remote Operation System and Vehicle Control System

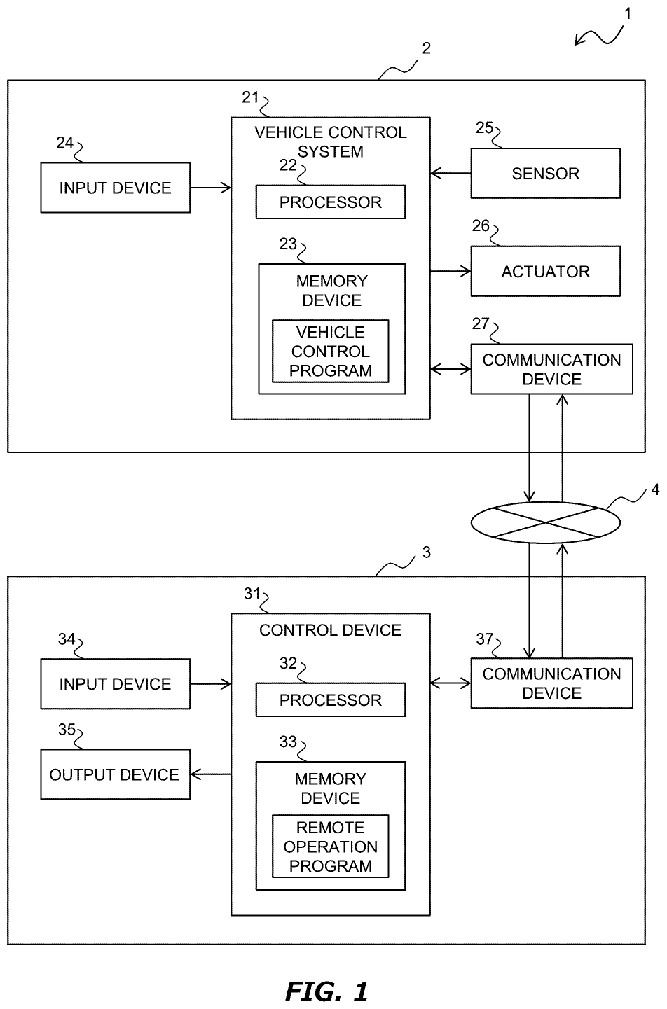

FIG. 1 is a diagram illustrating a configuration example of a remote operation system 1. The remote operation system 1 includes a vehicle 2 and a remote operation terminal 3. The vehicle 2 can be a target of remote operation by a remote operator. The vehicle 2 can be controlled by automatic driving and can be operated by manual driving of a driver in the vehicle 2. The remote operation terminal 3 is a device for a remote operator to perform remote operation, and is provided in a remote cockpit located at a place different from the vehicle 2. The remote cockpit is an operation seat for a remote operator to operate the remote operation terminal 3. The network 4 is a wireless communication network and connects the vehicle 2 and the remote operation terminal 3. The vehicle 2 and the remote operation terminal 3 may be directly connected via the network 4, or may be connected via a management device that manages the vehicle 2.

The vehicle 2 includes a vehicle control system 21, an input device 24, a sensor 25, an actuator 26, and a communication device 27.

The input device 24 is a device for a driver of the vehicle 2 to input an operation, and includes an accelerator pedal, a brake pedal, a steering wheel, and the like. The sensor 25 is an in-vehicle sensor, and includes a recognition sensor, a vehicle state sensor, a position sensor, and the like. The recognition sensor is a sensor that detects a situation around the vehicle 2, and includes a LIDAR, a camera, a radar, or the like. The vehicle state sensor is a sensor that detects a state of the vehicle 2, and includes a vehicle speed sensor, an acceleration sensor, a yaw rate sensor, a steering angle sensor, and the like. The position sensor is a sensor that detects a position and an azimuth of vehicle 2, and includes a global positioning system (GPS) sensor or the like. Communication device 27 communicates with the outside of vehicle 2. The connection destination of the communication device 27 includes at least the remote operation terminal 3.

The actuator 26 includes a steering device, a driving device, a braking device, and the like. The braking device includes a vehicle stop holding device having a vehicle stop holding function. The vehicle stop holding function is a function of holding the vehicle 2 in a stopped state even when the brake pedal is not depressed. The vehicle stop holding function is realized by, for example, an electronic parking brake (EPB), an automatic brake hold, or the like. The vehicle stop holding function operates under a predetermined condition. For example, when the driver turns on the EPB switch, the EPB is activated. As another example, when the driver depresses the brake pedal and the vehicle 2 stops, the automatic brake hold is activated. As still another example, the EPB may be automatically activated when the automatic brake hold continues for a certain period of time. The operation of the vehicle stop holding function is canceled when the driver depresses the accelerator pedal.

The vehicle control system 21 is a system that controls the vehicle 2. For example, the vehicle control system 21 performs autonomous driving control. When the vehicle 2 is remotely operated, the vehicle control system 21 controls the vehicle 2 on the basis of the operation amount input by the remote operator. The vehicle control system 21 is connected to the input device 24, the sensor 25, the actuator 26, and the communication device 27 via a predetermined network such as an in-vehicle network. The vehicle control system 21 includes one or more processors 22 (hereinafter, simply referred to as processors 22) and one or more memory devices 23 (hereinafter, simply referred to as memory devices 23). Typically, processor 22 is included in an electronic control unit (ECU) mounted on vehicle 2. The memory device 23 stores one or more programs including a vehicle control program. The vehicle control program is a program for controlling vehicle 2 based on various kinds of information including an operation amount input by a remote operator. When the processor 22 executes one or more programs stored in the memory device 23, control of the vehicle 2 including control by remote operation is realized.

The remote operation terminal 3 includes a control device 31, an input device 34, an output device 35, and a communication device 37. The input device 34 is a device through which a remote operator inputs an operation for remote control. Examples of the input device 34 include a steering wheel, an accelerator pedal, a brake pedal, a direction indicator, a touch panel, and the like. The output device 35 is a device for outputting information to a remote operator. The remote operator can perform remote control by referring to the information output from the output device 35. Examples of the output device 35 include a monitor, a speaker, and the like. The communication device 37 is a device for communicating with the outside of the remote operation terminal 3. The connection destination of the communication device 37 includes at least the vehicle 2.

The control device 31 is connected to the input device 34, the output device 35, and the communication device 37 via a predetermined network. The control device 31 includes one or more processors 32 (hereinafter, simply referred to as processors 32) and one or more storage devices 33 (hereinafter, simply referred to as storage devices 33). The storage device 33 stores one or more programs including a remote operation program. The remote operation program is a program for remotely operating the vehicle 2. When the processor 32 executes one or more programs stored in the storage device 33, various processes are executed by the remote operation terminal 3.

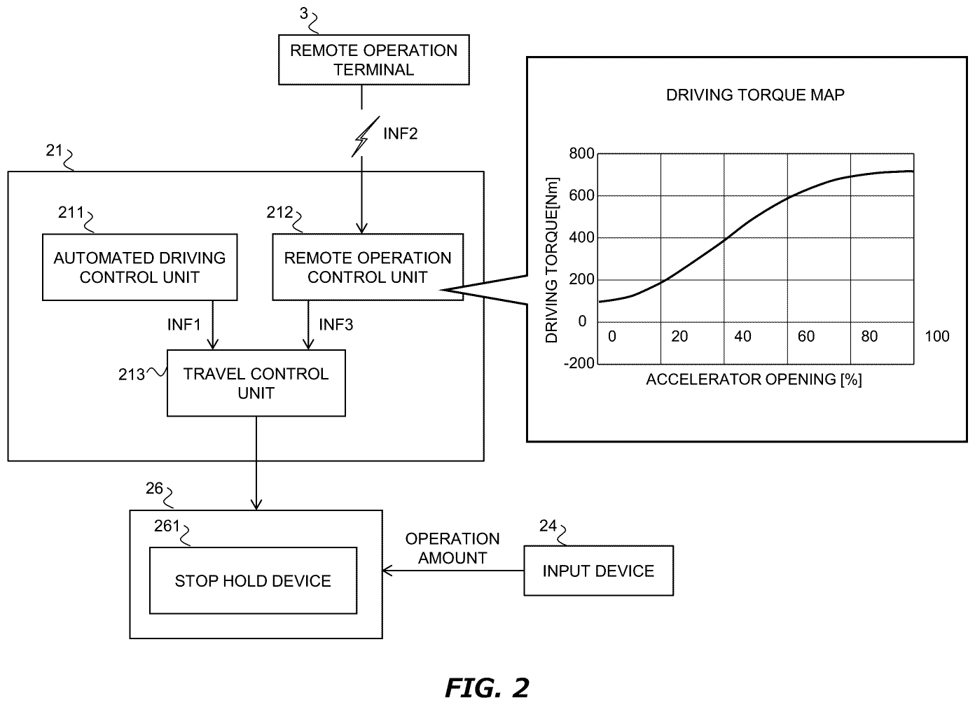

Next, control of the vehicle 2 by the vehicle control system 21 will be described with reference to FIG. 2.

In the example of FIG. 2, the vehicle control system 21 includes an automated driving control unit 211, a remote operation control unit 212, and a travel control unit 213 as functional units. Each functional unit of the vehicle control system 21 is realized by the processor 22 executing a program stored in the memory device 23. The functional configuration of the vehicle control system 21 is not limited to the example shown in FIG. 2. For example, the remote operation control unit 212 may be included in the automated driving control unit 211. The processor that realizes the plurality of functional units included in the vehicle control system 21 may be the single processor 22. Alternatively, the respective functional units may be realized by different processors 22. For example, an automated driving ECU, a remote operation ECU, and a vehicle motion ECU may be mounted on the vehicle 2, and each of the ECUs may function as the automated driving control unit 211, the remote operation control unit 212, and the travel control unit 213 by itself. In this case, the remote operation control unit 212 may be configured as a single device as a remote operation control device. Alternatively, a plurality of functional units included in the vehicle control system 21 may be realized by cooperation of a plurality of processors 22.

The automated driving control unit 211 controls automated driving of the vehicle 2. The automated driving control unit 211 calculates a control amount of the vehicle 2 based on the information acquired from the sensor 25, and outputs information INF1 including the calculated control amount to the travel control unit 213. The information INF1 includes the requested accelerations of the vehicle 2.

The remote operation control unit 212 controls remote operation of the vehicle 2. The remote operation control unit 212 acquires the information INF2 from the remote operation terminal 3 via the network 4 calculates information necessary for control of the vehicle 2 based on the acquired information INF2. The information INF2 includes information related to an operation amount input to the remote operation terminal 3 by the remote operator. For example, the information INF2 includes information such as the presence or absence of an input of an accelerator operation by a remote operator, the presence or absence of an input of a brake operation, and an operation amount of an accelerator pedal. The information calculated by the remote operation control unit 212 includes the required acceleration. Hereinafter, the processing performed by the remote operation control unit 212 to determine the required acceleration based on the operation amount input by the remote operator will be referred to as “first processing”. The information calculated by the remote operation control unit 212 is output as information INF3 and input to the travel control unit 213. The information INF3 includes the required accelerations determined by the first processing.

The travel control unit 213 controls the actuators 26 based on the information INF1 received from the automated driving control unit 211 or the information INF3 received from the remote operation control unit 212. Vehicle 2 is controlled in this manner.

When remotely operating the vehicle 2, it is desirable for the remote operator to operate the actuator 26 in the same manner as when driving the vehicle 2 as a driver. Therefore, the relationship between the operation by the remote operator and the behavior of the vehicle 2 will be considered by focusing on the operation of the stop hold device 261 included in the actuator 26, particularly, the cancellation of the activation of the vehicle stop holding function.

During manual driving, an operation amount input to the input device 24 by the driver is directly transmitted to the actuator 26, and the actuator 26 performs an operation according to the operation amount input by the driver. Regarding the stop hold device 261, when the driver depresses the accelerator pedal while the vehicle stop hold function is activated, the activation of the vehicle stop hold function is released. If there is no accelerator operation by the driver, the vehicle stop holding function continues to operate.

On the other hand, during the automatic driving, the travel control unit 213 cancels the operation of the vehicle stop holding function. To be more specific, the travel control unit 213 cancels the operation of the vehicle stop holding function when the requested speed included in the information INF1 becomes higher than 0, that is, when it is considered that the automated driving control unit 211 requests driving of the vehicle 2.

Even when the vehicle 2 is remotely operated, it is the travel control unit 213 that cancels the operation of the vehicle stop holding function. The amount of operation by the remote operator is first transmitted to the remote operation control unit 212, and the remote operation control unit 212 determines the required acceleration by the first processing. The required acceleration determined by the first processing is transmitted to the travel control unit 213, and the travel control unit 213 determines whether or not to release the operation of the vehicle stop holding function based on the transmitted required acceleration.

When the remote operation control unit 212 determines the required acceleration by the first processing, it is possible to use a relationship between the accelerator opening degree and the driving force can be used. By using the drive torque map, it is possible to bring the relationship between the operation amount of the accelerator pedal by the remote operator and the acceleration of the vehicle 2 close to that during manual driving. However, as shown in FIG. 2, since the phenomenon occurs, the driving torque when the accelerator opening degree is 0 becomes higher than 0 in the driving torque map. Hereinafter, in this specification, the driving torque when the accelerator opening degree is 0 is referred to as a driving force.

It is assumed that the travel control unit 213 performs the same determination as that at the time of automatic driving, and cancels the operation of the vehicle stop holding function when the required accelerations included in the information INF3 become higher than 0. At this time, it is assumed that the remote operation control unit 212 outputs the required accelerations in accordance with the driving torque map as the information INF3. In this case, even if the remote operator does not input the accelerator operation when the vehicle stop holding function is activated, the travel control unit 213 receives the input of the required acceleration corresponding to the driving force and cancels the activation of the vehicle stop holding function. For the remote operator, since the behavior of the stop hold device 261 is different from that when driving as a driver in the vehicle 2, there is a possibility that the remote operator may feel uncomfortable.

The vehicle control system 21 according to the present embodiment has been made in view of such a problem, and makes it possible to bring the behavior of the stop hold device 261 at the time of remote control close to that at the time of manual driving. Hereinafter, three Examples for solving the above-described problem will be described.

### 2. First Example

In the first Example, the first processing performed by the remote operation control unit 212 includes setting (correcting) the required acceleration to 0 or less when there is no input of the accelerator operation by the remote operator. A condition for the travel control unit 213 to cancel the operation of the vehicle stop holding function is set in the same manner as in the automatic driving. In other words, the travel control unit 213 cancels the operation of the vehicle stop holding function when the required accelerations determined by the first processing, that is, the required accelerations included in the information INF3 become higher than 0.

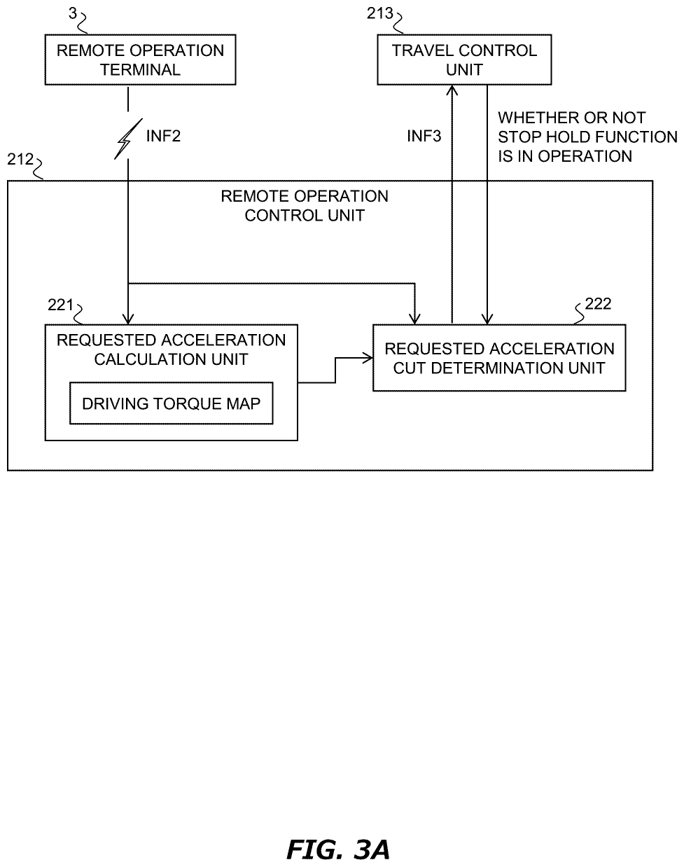

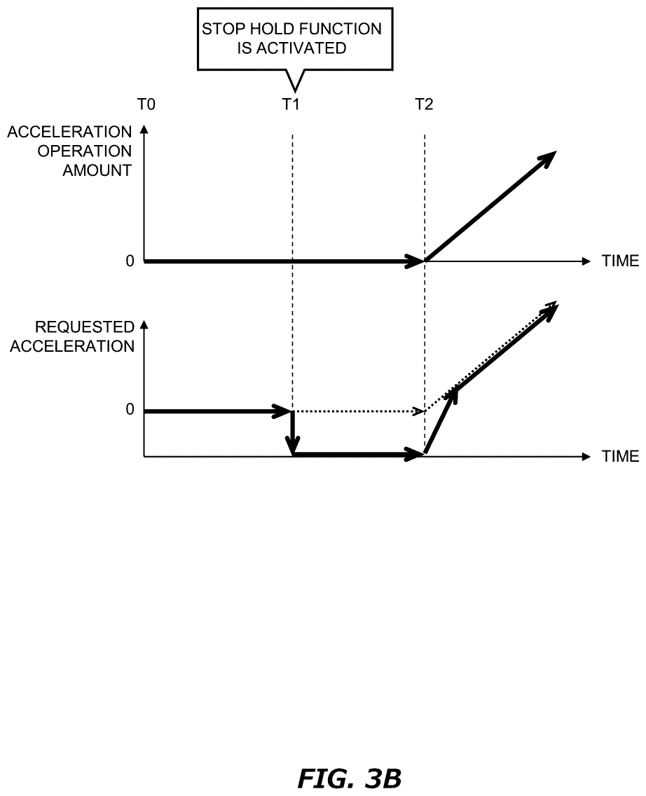

FIG. 3A shows an example of the configuration of the remote operation control unit 212 in the first Example. The remote operation control unit 212 further includes a requested acceleration calculation unit 221 and a requested acceleration cut determination unit 222 as functional units. The requested-acceleration calculation unit 221 calculates a requested-acceleration based on the information INF2 using the driving torque map. The calculated required acceleration is input to the requested acceleration cut determination unit 222. The requested acceleration cut determination unit 222 determines whether or not to cut the requested acceleration input from the requested acceleration calculation unit 221 based on whether or not the vehicle stop holding function is activated and whether or not the accelerator operation is input by the remote operator. The requested acceleration cut determination unit 222 cuts the requested acceleration when the operation input by the remote operator, the requested acceleration cut determination unit cuts the requested acceleration. That is, the requested acceleration cut determination unit 222 sets the requested acceleration to be equal to or less than 0 and outputs it as the information INF3 instead of the requested acceleration calculated by the requested acceleration calculation unit 221. When the vehicle stop holding function is not in operation or when the accelerator operation is input by the remote operator, the requested acceleration cut determination unit 222 does not cut the requested acceleration and outputs the requested acceleration received from the requested acceleration calculation unit 221 as it is as the information INF3.

FIG. 3B is a time chart showing the relationship between the accelerator operation amount input to the remote operation control unit 212 and the required acceleration output from the remote operation control unit 212 when the remote operation control unit 200 is configured as shown in FIG. 3A. At time T1, a predetermined condition necessary for activation of the vehicle stop holding function is satisfied, and the vehicle stop holding function is activated. During a period from time T1 to time T2, the vehicle stop holding function is in operation and there is no accelerator operation input by the remote operator, so that the requested acceleration-cut determination unit 222 cuts the requested acceleration-cut. Therefore, the required acceleration is a value of 0 or less. Since the required acceleration is equal to or less than 0, the travel control unit 213 continues the operation of the vehicle stop holding function.

After time T2, since the remote operator inputs the accelerator operation, the requested acceleration-cut determination unit 222 does not cut the requested acceleration-cut, and the requested acceleration-output from the remote operation control unit 212 becomes higher than 0. Then, the travel control unit 213 cancels the operation of the vehicle stop holding function. As shown in FIGS. 3A and 3B, the requested acceleration cut determination unit 222 may gradually change the requested acceleration in order to prevent a sudden change in the requested acceleration.

The configuration of the remote operation control unit 212 is not limited to the example shown in FIG. 3A. For example, the remote operation control unit 212 may include a gain determination unit, a calculation unit, and a selection unit instead of the requested acceleration cut determination unit 222. The gain determination unit determines the gain to be 0 when the vehicle stop holding function is in operation and there is no input of the accelerator operation by the remote operator, and otherwise determines the gain to be 1. The required acceleration calculated by the requested acceleration calculation unit 221 and the gain determined by the gain determination unit are input to the calculation unit. The calculation unit multiplies the required acceleration by the gain. The required acceleration calculated by the requested acceleration calculation unit 221 and the calculation result of the calculation unit are input to the selection unit. The selector selects the smallest value among the input values and outputs it as information INF3 to the travel control unit 213.

In this case, if the same accelerator operation as in the time chart of FIG. 3B is input, the gain determined by the gain determination unit is 1 from time T0 to time T1 and after time T2, and is 0 from time T1 to time T2. In other words, the requested accelerations to be output are the requested accelerations calculated by the requested acceleration calculation unit 221 from time T0 to time T1 and after time T2, and are 0 from time T1 to time T2. The gain determination unit may output the gain subjected to the gradual change processing at the time T2.

In this configuration as well, travel control unit 213 continues the operation of the vehicle stop holding function from time T1 to time T2 because the required accelerations are 0, and cancels the operation of the vehicle stop holding function in response to the required accelerations becoming higher than 0 at time T2.

As described above, it is possible to prevent the vehicle stop holding function from being deactivated even when there is no accelerator operation input by the remote operator. Further, according to the first Example, it is not necessary to output additional information other than the information INF3 from the remote operation control unit 212 to the travel control unit 213. That is, there is no need to change the interface between the remote operation control unit 212 and the travel control unit 213. This is preferred from a design point of view.

### 3. Second Example

In a second Example, the remote operation control unit 212 includes the requested acceleration calculation unit 221 but does not include the requested acceleration cut determination unit 222. The remote operation control unit 212 outputs the requested accelerations calculated by the requested accelerations calculation unit 221 as information INF3.

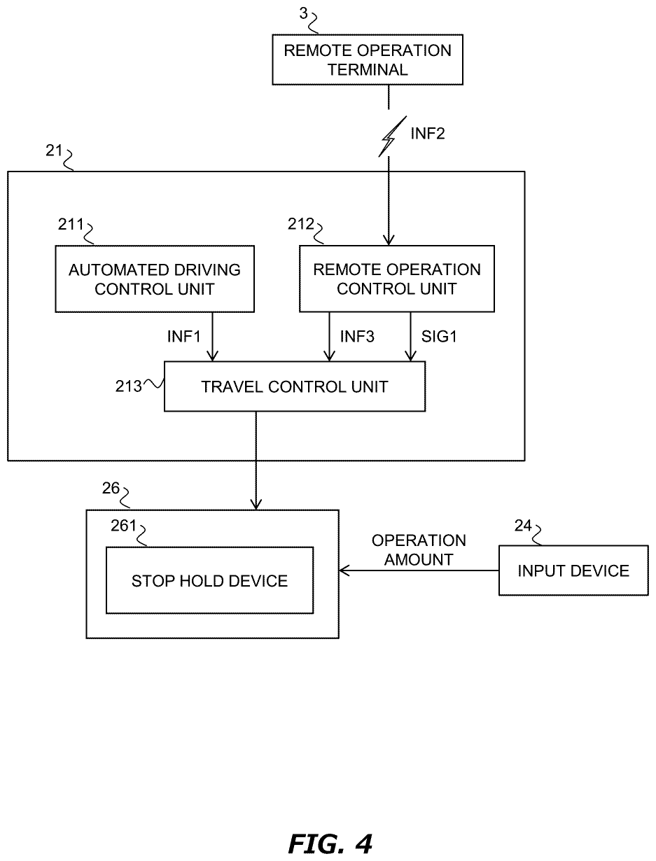

FIG. 4 is a diagram showing an example of a configuration of the vehicle control system 21 according to the second Example. The remote operation control unit 212 outputs the discrimination signal SIG1 to the travel control unit 213 together with the required accelerations determined by the first processing. The discrimination signal SIG1 indicates that the requested accelerations are determined by the remote operation control unit 212 (first processing). The travel control unit 213 can identify that the received required accelerations are the required accelerations determined by the first processing by the identification signals SIG1.

When the required acceleration determined by the first processing is received during the operation of the vehicle stop holding function, the travel control unit 213 determines whether or not the received required acceleration is higher than the threshold value. The threshold value is a required acceleration corresponding to the driving force. When the required acceleration determined by the first processing is equal to or less than the threshold value, there is a possibility that the required acceleration is caused by the driving force not caused by the accelerator operation. Therefore, when the required acceleration determined by the first processing is equal to or less than the threshold value, the travel control unit 213 determines that there is no input of the accelerator operation by the remote operator and continues the operation of the vehicle stop holding function. On the other hand, when the required acceleration determined by the first processing becomes higher than the threshold value, the travel control unit 213 deems that there is an input of the accelerator operation by the remote operator and cancels the operation of the vehicle stop holding function. Even with such a method, it is possible to prevent the vehicle stop holding function from being deactivated even when there is no input of the accelerator operation by the remote operator.

When the travel control unit 213 does not receive the identifying signal SIG1, the travel control unit 213 does not make the determination regarding the thresholds of the required accelerations. In other words, when the required acceleration is received from the automated driving control unit 211, the travel control unit 213 cancels the operation of the vehicle stop holding function if the required acceleration is higher than 0.

### 4. Third Example

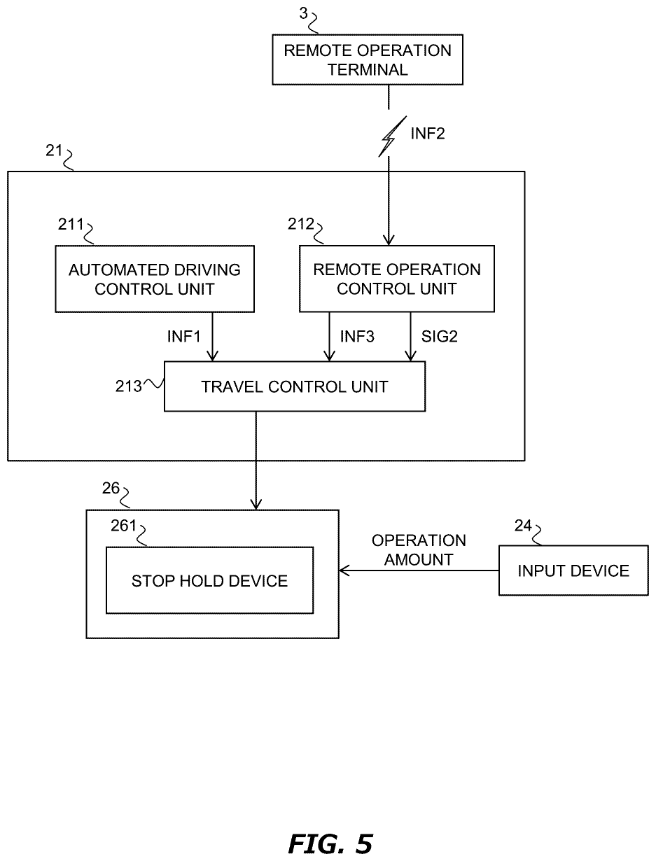

FIG. 5 is a diagram showing an example of a configuration of the vehicle control system 21 according to the third Example. The third Example is a modified example of the second Example. The remote operation control unit 212 outputs the signal SIG2 to the travel control unit 213 together with the required accelerations determined by the first processing. The signal SIG2 indicates the presence or absence of the input of the accelerator operation by the remote operator in addition to the same matter as that of the discrimination signal SIG1. The travel control unit 213 determines whether or not to cancel the operation of the vehicle stop holding function on the basis of the signal SIG2 in a case where the travel control unit 140 receives the requested accelerations determined by the first processing during the operation of the vehicle stop holding function.

When the signal SIG2 indicates that there is no accelerator operation input by the remote operator, the travel control unit 213 continues the operation of the vehicle stop holding function even if the required accelerator determined by the first processing becomes higher than 0. When the signal SIG2 indicates that there is an input of an accelerator operation by the remote operator, the travel control unit 213 cancels the operation of the vehicle stop holding function when the required accelerator determined by the first processing becomes higher than 0. According to the third Example, the process of comparing the required acceleration with the threshold value in the travel control unit 213 becomes unnecessary.

### 5. Flowchart

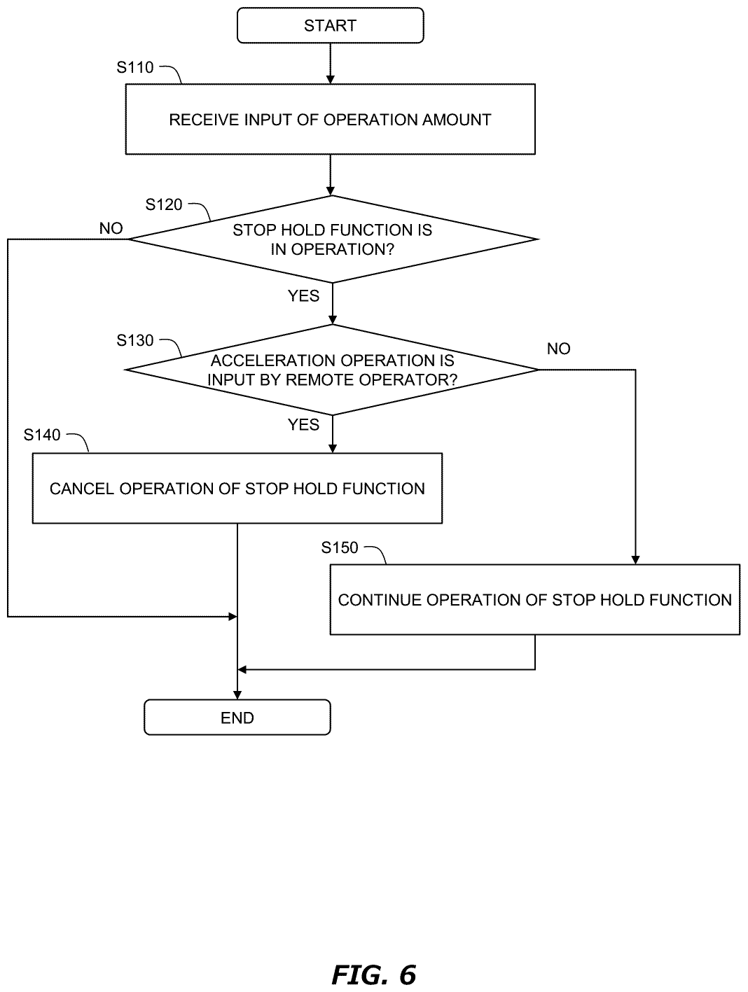

To summarize the three Examples described above, the flow of processing performed by the vehicle control system 21 can be represented by the flowchart of FIG. 6. The processing shown in FIG. 6 is realized by the processor 22 executing the vehicle control program.

In step S110, the vehicle control system 21 receives an input of an operation amount by the remote operator. This processing is executed by the remote operation control unit 212. When the input is accepted, the process proceeds to step S120.

In step S120, the vehicle control system 21 determines whether or not the vehicle stop holding function is in operation. When the vehicle stop holding function is in operation (Yes at Step S120), the processing proceeds to Step S130. When the vehicle stop holding function is not in operation (step S120: No), the processing ends. This determination is executed by the travel control unit 213. The travel control unit 213 can determine whether 261, the travel control unit can determine whether by acquiring information from the stop hold device.

In step S130, the vehicle control system 21 determines whether or not an accelerator operation is input by the remote operator. When the accelerator operation has been input (step S130; Yes), the processing proceeds to step S140. When there is no input of the accelerator operation (step S130; No), the processing proceeds to step S150. This determination is executed by the remote operation control unit 212 or the travel control unit 213.

In step S140, the vehicle control system 21 cancels the vehicle stop holding function. This processing is executed by the travel control unit 213. When the vehicle stop holding function is canceled, the processing ends.

In step S150, the vehicle control system 21 continues the vehicle stop holding function. That is, the process ends without the travel control unit 213 canceling the vehicle stop holding function.

According to the above-described processing, when the vehicle stop holding function is activated, it is possible to prevent the activation of the vehicle stop holding function from being cancelled even though there is no input of the accelerator operation by the remote operator. For the remote operator, it is possible to reduce the feeling of strangeness caused by the difference between the behavior of the vehicle 2 and the behavior when driving the vehicle 2 as a driver.

What is claimed is:

1. A vehicle control system that controls a vehicle based on an operation amount input by a remote operator, the vehicle control system comprising one or more processors, wherein
when a stop hold function that holds a stopped state of the vehicle is in operation, the one or more processors are configured to:
continue the operation of the stop hold function when an acceleration operation is not input by the remote operator; and
cancel the operation of the stop hold function when the acceleration operation is input by the remote operator.

2. The vehicle control system according to claim 1, wherein
the one or more processors are further configured to:
execute a first process that determines a requested acceleration based on the operation amount input by the remote operator; and
cancel the operation of the stop hold function when the requested acceleration determined by the first process becomes higher than 0, and
the first process includes setting the requested acceleration to 0 or less when the acceleration operation is not input by the remote operator.

3. The vehicle control system according to claim 1, wherein the one or more processors are further configured to:
execute a first process that determines a requested acceleration based on the operation amount input by the remote operator;
continue the operation of the stop hold function when the requested acceleration determined by the first process is equal to or less than a threshold value; and
cancel the operation of the stop hold function when the requested acceleration determined by the first process becomes higher than the threshold value.

4. The vehicle control system according to claim 1, wherein the one or more processors are further configured to:
execute a first process that determines a requested acceleration based on the operation amount input by the remote operator;
generate a signal indicating whether or not the acceleration operation is input by the remote operator;
when the signal indicates that the acceleration operation is not input, continue the operation of the stop hold function even if the requested acceleration determined by the first process becomes higher than 0; and
cancel the operation of the stop hold function when the signal indicates that the acceleration operation is input and the requested acceleration determined by the first process becomes higher than 0.

5. A control device mounted on a vehicle comprising a stop hold function that holds a stopped state of the vehicle, the control device comprising one or more processors, wherein
the one or more processors are configured to:
receive an operation amount input by a remote operator from a remote cockpit; and
execute a first process that determines a requested acceleration based on the received operation amount,
the first process includes setting the requested acceleration to 0 or less when an acceleration operation is not input by the remote operator, and
an operation of the stop hold function is canceled when the requested acceleration determined by the first process becomes higher than 0.
